(19) United States
(12) Patent Application Publication
(10) Pub. No.: US 2007/0109561 A1
(43) Pub. Date: May 17, 2007

(54) Operating information recording method, operating information reproducing method, operating information storing method and apparatus and programs of the same

(76) Inventor: Tadashi Suzue, Tokyo (JP)

Correspondence Address: CANTOR COLBURN, LLP, 55 GRIFFIN ROAD SOUTH, BLOOMFIELD, CT, 06002, US

(21) Appl. No.: 11/506,007

(22) Filed: Aug. 17, 2006

(30) Foreign Application Priority Data
Nov. 16, 2005 (JP) JP2005-331604

(51) Int. Cl. G06F 3/12

(52) U.S. Cl. 358/1.1; 358/1.15

(57) ABSTRACT

There is described an operating information recording method, which makes it easy to grasp the contents of the operations conducted for the apparatus. Such the operating information recording method includes the steps of: storing operating procedure information including consecutive operating information according to an operating procedure against to an apparatus as a procedure in time series; storing operating screen information with respect to consecutive operating screens to be displayed on a display section corresponding to the operating procedure, while correlating the operating screen information with the operating procedure information; and storing output data information with respect to output data, which are outputted form the apparatus operated according to the operating procedure, while correlating the output data information with the operating procedure information and the operating screen information. The apparatus could be an image forming apparatus, and the output data could be image data including thumbnail image data.

This application is based on Japanese Patent Application No. 2005-331604 filed on Nov. 16, 2005 in Japanese Patent Office, the entire content of which is hereby incorporated by reference.

### BACKGROUND OF THE INVENTION

The present invention relates to an operating information recording method, an operating information reproducing method, an operating information storing method and apparatus and programs of the same.

Conventionally, there have been proposed various kinds of technologies to improve the user's availability and maneuverability of an image forming apparatus, such as a copier, a facsimile, a printer, etc., which serves as an operational object. As the representative of such the technologies, an operational panel, in which a display device and a touch panel are integrally incorporated, has been practically employed in the various kinds of image forming apparatuses. When the user changes the setting conditions for the image forming operation, such as density, contrast, etc., by operating the touch panel, the operational keys, etc., which are included in the operating section, the hardware processing and the software processing of the image forming apparatus are controlled on the basis of the setting conditions changed by the user, so as to form an image, which complies with the setting conditions desired by the user, on a recording medium to be outputted.

Further, there has been devised the system in which the remote-control operation of the image forming apparatus is possible through the network. Concretely speaking, for instance, Patent Document 1 (JP-3042655, Official Gazette of Japanese Patent) sets forth the system in which the remote-control operation of the image forming apparatus is achieved by displaying the operational keys on the display screen of the workstation and transmitting the command signals, corresponding to the operational keys operated through the mouse cursor by the user, to the operational section of the image forming apparatus through the network. In addition, for instance, Patent Document 2 (JP-3327566, Official Gazette of Japanese Patent) sets forth the system in which the coordinate data of the position clicked in the computer screen is transmitted to the copier, and the copier determines the operation designated by the computer from the coordinate data received from the computer so as to conduct the operation concerned.

Incidentally, when it is required to recognize the detailed contents of the operations, in order to analyze the malfunction of the image forming apparatus, etc., conventionally, such the malfunction analysis has been conducted by referring to the data contents stored as the operational log information. Since such the operational log information are text information, however, it has been difficult to determine what kind of operation was practically conducted. In addition, since the contents outputted as the operating results are not clear, it has been difficult to grasps the accurate state of the operations.

### SUMMARY OF THE INVENTION

To overcome the abovementioned drawbacks in conventional image forming apparatus, it is an object of the present invention to provide an image forming apparatus, which makes it easy to grasp the contents of the operations conducted for the apparatus.

Accordingly, to overcome the cited shortcomings, the abovementioned object of the present invention can be attained by operating information recording methods, operating information reproducing methods, apparatuses and computer programs described as follow.
(1) An operating information recording method, comprising: storing operating procedure information including consecutive operating information according to an operating procedure against to an apparatus as a procedure in time series; and storing operating screen information with respect to consecutive operating screens to be displayed on a display section corresponding to the operating procedure, while correlating the operating screen information with the operating procedure information.
(2) An operating information reproducing method, comprising: acquiring operating procedure information including consecutive operating information according to an operating procedure against to an apparatus as a procedure in time series; acquiring operating screen information with respect to consecutive operating screens correlated with the operating procedure information; and displaying the consecutive operating screens on a display section corresponding to the operating procedure, and at a same time, displaying an operating pointer for indicating the operating procedure on the consecutive operating screens, based on the operating procedure information and the operating screen information.
(3) An operating information reproducing method, comprising: acquiring operating procedure information including consecutive operating information according to an operating procedure against to an apparatus as a procedure in time series; acquiring operating screen information with respect to consecutive operating screens correlated with the operating procedure information; and displaying the consecutive operating screens on a display section corresponding to the operating procedure, and at a same time, generating a dynamic picture image file for displaying an operating pointer for indicating the operating procedure on the consecutive operating screens, based on the operating procedure information and the operating screen information; and storing the dynamic picture image file.
(4) An apparatus, comprising: a display section; a storage section to store information; and a control section to control the storage section so as to store operating procedure information including consecutive operating information according to an operating procedure as a procedure in time series and operating screen information with respect to consecutive operating screens to be displayed on the display section corresponding to the operating procedure, while correlating the operating screen information with the operating procedure information.
(5) An apparatus, comprising: a display section; and a control section to acquire operating procedure information including consecutive operating information according to an operating procedure against to an apparatus as a procedure in time series, and operating screen information with respect to consecutive operating screens correlated with the operating procedure information, and to control the display section so as to display the consecutive operating screens on the display section corresponding to the operating procedure, and at a same time, so as to display an operating pointer for indicating the operating procedure on the consecutive operating screens, based on the operating procedure information and the operating screen information.
(6) An apparatus, comprising: a storage section to store information; and a control section to acquire operating procedure information including consecutive operating information according to an operating procedure against to an apparatus as a procedure in time series, and operating screen information with respect to consecutive operating screens correlated with the operating procedure information, and to control the display section so as to display the consecutive operating screens on a display-section corresponding to the operating procedure, based on the operating procedure information and the operating screen information, and to generate a dynamic picture image file for displaying an operating pointer for indicating the operating procedure on the consecutive operating screens, based on the operating procedure information and the operating screen information, so as to store the dynamic picture image file in the storage section.
(7) A computer program for executing a specific operation against to an apparatus, comprising the functional steps of: storing operating procedure information including consecutive operating information according to an operating procedure against to an apparatus as a procedure in time series; and storing operating screen information with respect to consecutive operating screens to be displayed on a display section corresponding to the operating procedure, while correlating the operating screen information with the operating procedure information.
(8) A computer program for executing a specific operation against to an apparatus, comprising the functional steps of: acquiring operating procedure information including consecutive operating information according to an operating procedure against to an apparatus as a procedure in time series; acquiring operating screen information with respect to consecutive operating screens correlated with the operating procedure information; and displaying the consecutive operating screens on a display section corresponding to the operating procedure, and at a same time, displaying an operating pointer for indicating the operating procedure on the consecutive operating screens, based on the operating procedure information and the operating screen information.
(9) A computer program for executing a specific operation against to an apparatus, comprising the functional steps of: acquiring operating procedure information including consecutive operating information according to an operating procedure against to an apparatus as a procedure in time series; acquiring operating screen information with respect to consecutive operating screens correlated with the operating procedure information; and displaying the consecutive operating screens on a display section corresponding to the operating procedure, and at a same time, generating a dynamic picture image file for displaying an operating pointer for indicating the operating procedure on the consecutive operating screens, based on the operating procedure information and-the operating screen information; and storing the dynamic picture image file.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an example of a brief configuration of a remote operating system;

FIG. 2 shows an example of remote operating screen;

FIG. 3 shows an example of a functional configuration of a remote operating system;

FIG. 4 shows an example of a data structure of script data;

FIG. 5 shows a flowchart of an operating information recording processing;

FIG. 6 shows an example of an operating screen;

FIG. 7 shows an example of an operating screen;

FIG. 8 shows an example of an operating screen;

FIG. 9 shows an example of an operating screen;

FIG. 10 shows an example of an operating screen;

FIG. 11 shows an example of an operating screen;

FIG. 12 shows an example of an operating screen;

FIG. 13 shows an example of an operating screen;

FIG. 14 shows an example of output images;

FIG. 15 shows a flowchart for explaining an operating information reproducing processing; and

FIG. 16 shows an example of a table of output images.

### DETAILED DESCRIPTION OF THE PREFERRED EMBODIMENT

<Summary of Remote Operating System>

Referring to the drawings, a remote operating system embodied in the present invention will be detailed in the following.

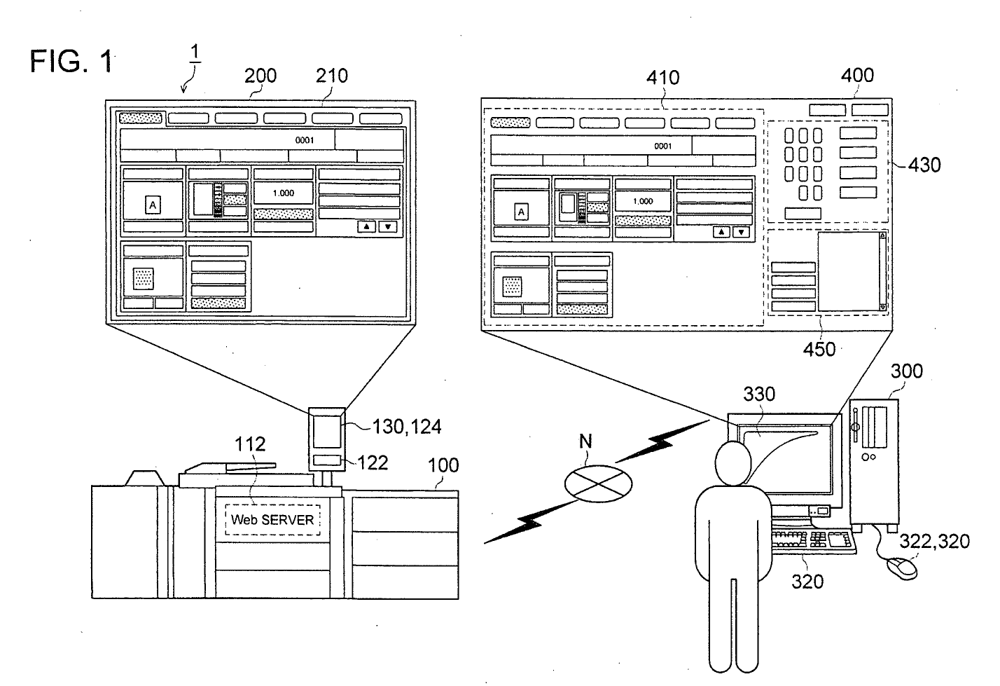

FIG. 1 shows an example of a brief configuration of a remote operating system 1. As shown in FIG. 1, the remote operating system 1 is constituted by a copier 100 serving as an apparatus of remote operating object and a remote terminal device 300, and is communicatively coupled to them through a communication network N including hard-wired and/or wireless communication paths. Although the present embodiment will be detailed by exemplifying a copier serving as an example of the image forming apparatus in the following, it is needless to say that another image forming apparatus, such as a facsimile, a printer, etc., is also applicable in the present invention.

As shown in FIG. 1, the copier 100 is provided with a display section 130 over that a touch panel 124 is mounted and a hard keys section 122. The user can conduct a changing operation of various kinds of setting conditions, an instructing operation of the copy commencement, etc. in regard to the copier 100, by pushing down the hard keys section 122 or touching the touch panel 124. A main operating panel screen 210 from which various kinds of setting conditions can be inputted into the copier 100 and a main operating screen 200, which includes an operating status, etc., are displayed on the display section 130.

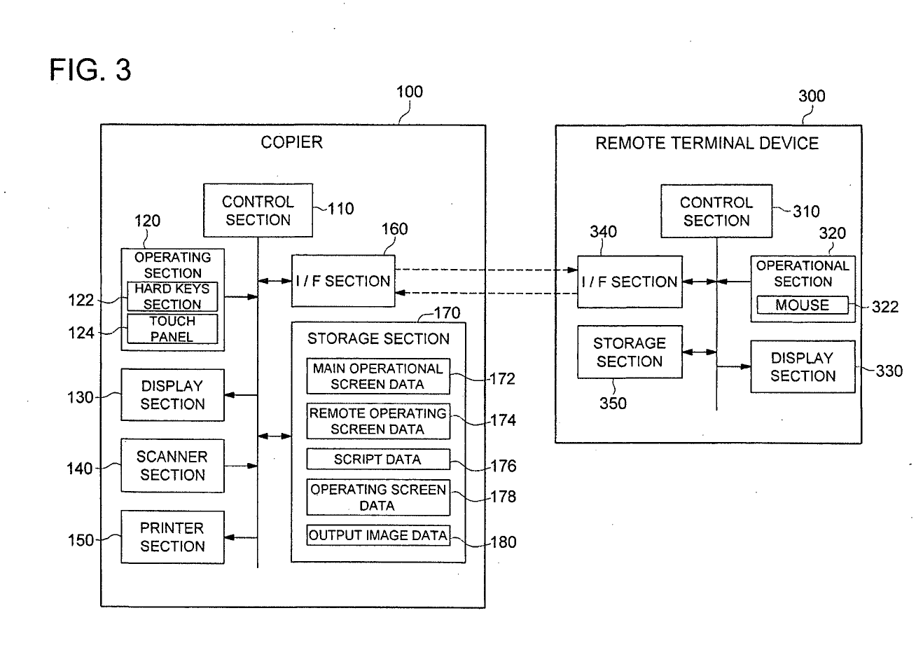

Further, the copier 100 also has a function as a Web server 112. When the copier 100 is coupled to the communication network N based on the communication protocol, such as the TCP/IP, etc., the Web server 112 can be accessed from an external device. In response to the requesting command sent from the remote terminal device 300 serving as the accessing external device, the Web server 112 transmits remote operating screen data 174 (refer to FIG. 3) to the remote terminal device 300 so as to display a remote operating screen 400 including a screen same as the main operating panel screen 210.

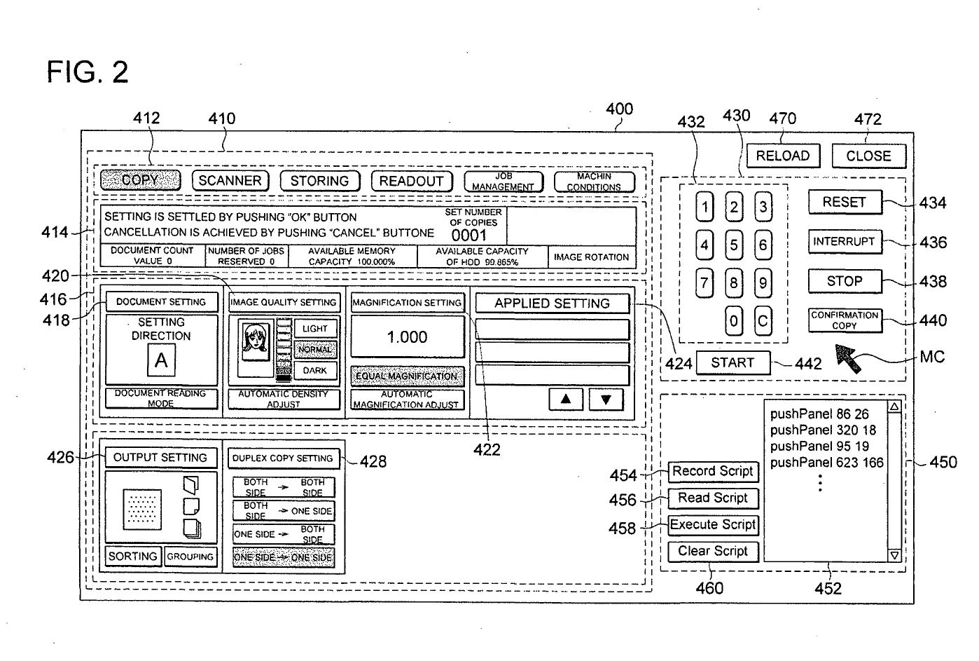

The remote terminal device 300 serves as a client terminal device for remote-controlling the operations of the copier 100, and for instance, is constituted by a personal computer, a PDA (Personal Digital Assistant), etc. As shown in FIG. 1, the remote terminal device 300 is provided with an operational section 320 having a keyboard and a mouse 322, and a display section 330. Further, the remote terminal device 300 has a function as the Web browser. When the remote terminal device 300 is coupled to the communication network N based on the communication protocol, such as the TCP/IP, etc., the remote terminal device 300 displays the remote operating screen 400 shown in FIG. 2 on the display section 330, based on the remote operating screen data 174 transmitted from the copier 100.

As shown in FIG. 2, the remote operating screen 400 includes a remote setting panel 410, a hard keys panel 430 and a script panel 450. The contents of the remote setting panel 410 are the same as those of the main operating panel screen 210 to be displayed at the copier 100, namely, the remote setting panel 410 is constituted by a tab button 412, an operating status indication area 414 and an individual item setting area 416. The tab button 412 is used for switching the display of setting items, which are classified into-various kinds of functions. The operating status indication area 414 is used for displaying the operating contents currently implemented in the copier 100, the current using status of the copier 100, etc. The individual item setting area 416 is used for setting the individual items included in the function switched by the tab button 412.

In the remote setting panel 410 shown in FIG. 2, the copy function is selected by using the tab button 412, and a document setting button 418 for setting the direction of the image to be read, etc., an image quality setting button 420 for setting a density of the copy, a magnification setting button 422 for setting a magnification, an applied setting button 424 for setting applied function, an output setting button 426 for setting the post processing (such as a staple processing, a sort processing, etc.) to be applied to the recorded paper sheets and a duplex copy setting button 428 for setting the duplex copy mode are displayed within the individual item setting area 416. When the user clicks the mouse 322 while adjusting a mouse cursor MC, serving as a operation pointer, onto each of the abovementioned setting buttons, the setting panel corresponding to each of the setting items is displayed in the Windows format, so that the user can conducts the detailed setting operation on the setting panel displayed. The operation pointer is defined as such a symbol that is shaped in an arrow and moves with a dragging action of the mouse 322.

The hard keys panel 430 is displayed as a group of buttons copied from the hard keys section 122 of the copier 100, and includes a numerical button 432, a reset button 434 for resetting the setting contents, an interrupt button 436 for activating the interrupt processing during the copy operation, a stop button 438 for stopping the copy operation, a confirmation copy button 440 for activating the confirmation copy operation and a start button 442 for commencing the copy operation.

The user can conduct setting operations at the time of the copy operation by touching the various kinds of buttons displayed on the main operating panel screen 210 of the copier 100 side, and can conduct the copy commencing operation or the copy resetting operation by pushing down the corresponding buttons included in the hard keys section 122. On the other hand, the other user located at the site of the remote terminal device 300 can conducts the operations same as those conducted by touching the various kinds of buttons displayed on the main operating panel screen 210 of the copier 100 side or by pushing down the buttons included in the hard keys section 122, by remote-controlling the copier 100 and clicking the various kinds of buttons included in the remote setting panel 410 and the hard key panel 430.

Every time when the user clicks any one of the buttons displayed on the remote operating screen 400, the operation information representing the content of the operation concerned are sequentially recorded one by one as the time sequential domain in the copier 100. In the present embodiment, the operation information mentioned in the above is defined as script data 176 (refer to FIG. 3). The script data 176 make it possible to reproduce the consecutive operations conducted by the user so as to resume the various kinds of setting conditions set by the user.

The script panel 450 serves as an operational panel for controlling the script data 176, and includes a script indicating area 452 for indicating the contents of the script data 176, a recording button 454, a readout button 456, an implementation button 458 and a clear button 460.

After clicking the recording button 454, the user conducts the various kinds of setting operations by clicking the buttons included in the remote setting panel 410 and/or the hard key panel 430. Every time when the user clicks any one of the buttons mentioned in the above, the operation information are stored in the copier 100 and, at the same time, displayed on the script indicating area 452. In addition, at the time of each operation, the image data of the operating screen indicated on the display section 330 (namely, the remote operating screen data 174) are stored as operating screen data 178 (refer to FIG. 3) with the record of the operation information, while correlating with each of the operation information. Then, at the time when the user clicks the start button 442, the record of the script data 176 and the operating screen data 178 is finalized. At this time, the image data representing the output image (output image data 180) are also stored, while correlating the output image data 180 with the script data 176 and the operating screen data 178.

Further, when the user clicks the readout button 456, a control section 110 reads out the script data 176 stored in the copier 100. Then, at the time when the user clicks the implementation button 458, the control section 110 reproduces the consecutive operations, which were conducted once by the user, and resumes the various kinds of setting conditions acquired through the consecutive operations. The clear button 460 is used for deleting the script data 176 already stored in the copier 100, or the other script data 176 currently stored.

Still further, a reload button 470 and a close button 472 are displayed in the area located at the upper right position of the remote operating screen 400. When the user clicks the reload button 470, the remote terminal device 300 sends the transmitting request of the newest remote operating screen data 174 to the copier 100, so as to revise the display of the remote operating screen 400. The close button 472 is used for closing the remote operating screen 400.

<Configuration of Remote Terminal Device>

FIG. 3 shows an example of the functional configuration of the remote operating system 1. At first, the functional configuration of the remote terminal device 300 will be detailed in the following. As shown in FIG. 3, the remote terminal device 300 is provided with a control section 310, the operational section 320, the display section 330, an I/F section 340 and a storage section 350.

The control section 310 is constituted by CPU (Central Processing Unit), ROM (Read Only Memory), RAM (Random Access Memory), etc., and implements the various kinds of processing based on the predetermined programs in response to the inputted command signals, and also conducts the input/output operations of data and command signals from/to each of the functional sections, so as to totally manage and control the remote terminal device 300. Concretely speaking, in response to operational signals inputted from the operational section 320, the CPU reads out a program stored in the ROM or the storage section 350, and then, displays the results of the processing executed according to the program concerned.

The operational section 320 is provided with the keyboard, having cursor keys, ten keys, various kinds of function keys, etc., and the pointing device, such as the mouse 322, etc., so as to output the push-down signal of the pushed key, the positional signals of the mouse 322, etc. to the control section 310.

The display section 330 is constituted by a CRT (Cathode Ray Tube), a LCD (Liquid Crystal Display), etc. so as to display various kinds of screens based on the display data inputted from the control section 310.

The I/F section 340 serves as a functional section for coupling the remote terminal device 300 to the communication network N so as to conduct the data communication through the communication network N. The I/F section 340 is provided with a modem, a LAN (Local Area Network) interface, a USB port, etc.

The storage section 350 serves as a functional section for conducting the data read/write operations for the storage medium, such as, for instance, a CD-ROM, a-memory card, a hard disc drive, etc. A magnetic storage medium, an optical storage medium, a semiconductor storage medium, etc. can be employed as the abovementioned storage medium, which stores application programs, various data processed by executing various kinds of processing programs, etc.

The control section 310 serves as the Web browser to display the remote operating screen 400 on the display section 330. In addition, based on the positional signals of the mouse 322, outputted from the operational section 320, the control section 310 acquires (x, y) coordinate values of the mouse cursor MC on the remote operating screen 400, and then, transmits the acquired coordinate data to the copier 100 through the I/F section 340 so as to request a transmission of the remote operating screen data 174. Then, when receiving the remote operating screen data 174 transmitted from the copier 100, the control section 310 changes the remote operating screen 400 to new one based on the remote operating screen data 174. According to this operation, the remote terminal device 300 displays the remote operating screen 400 based on the remote operating screen data 174 transmitted by the web server 112.

Further, the control section 310 receives the script data 176, the operating screen data 178 and the output image data 180 from the copier 100, in order to display the consecutive operational screens corresponding to the operating procedure on the display section 330 and to display the mouse cursor MC indicating the operating procedure on the screen of the consecutive operations, based on the script data 176 and the operating screen data 178. Still further, based on the output image data 180, the control section 310 displays the output image outputted by the copier 100 onto the display section 330. Yet further, the control section 310 generates a moving image file for displaying the consecutive operational screens including the movement of the mouse cursor MC and the output image, and then, stores the generated moving image file into the storage section 350.

<Configuration of Copier>

Next, a functional configuration of the copier 100 will be detailed in the following. As shown in FIG. 3, the copier 100 is provided with the control section 110, an operating section 120, the display section 130, a scanner section 140, a printer section 150, an I/F section 160 and a storage section 170.

The control section 110 is constituted by a CPU (Central Processing Unit), a ROM (Read Only Memory), a RAM (Random Access Memory), etc., in order to execute processing based on the predetermined programs in response to the command signals inputted from the operating section 120 and conduct input/output operations of the instructions and data from/to each of the functional sections, so as to totally manage and control the copier 100.

The operating section 120 is provided with the hard keys section 122 including various kinds of keys, such as numeral keys, a start key, a reset key, etc., to output the push-down signals corresponding to the pushed-down keys in the hard keys section 122 to the control section 110. Further, the operating section 120 is also provided with a touch panel integrally formed with the display section 130, so as to detect a position on the touch panel 124 touched by the finger tip of the user or a touch pen and to output the detected positional signal to the control section 110.

The display section 130 is constituted by the CRT, the LCD, etc., over which a transparent touch panel is mounted. In response to instructions sent from the control section 110, the display section 130 displays various kinds of screens to be outputted. Concretely speaking, the display section 130 displays the main operating screen 200 based on main operational screen data 172 stored in the storage section 170. The control section 110 compares the positional signals, representing the touched position on the touch panel 124, with the main operational screen data 172, in order to determine which button included in the main operating screen 200 was touched by the user. Then, the control section 110 executes the processing corresponding to the button pushed by the user, for instance, changing the copy setting, revising the main operational screen data 172, etc.

The scanner section 140 has a function for reading an image residing on the document, put on the document stacking tray, to generate image data representing the image. Concretely speaking, when the start key in the operating section 120 is pushed, the scanner section 140 conveys the document put on the document stacking tray to the contact glass at which the light, originally emitted from a light source and irradiated onto the document, is reflected from the document, and then, the reflected light travels into the CCD (Charge Coupled Device) image sensor through a mirror unit and the focusing lens so as-to read the reflected light as the image data.

The printer section 150 has a function for forming an image onto a transfer material. Concretely speaking, in the printer section 150, the photoreceptor drum is exposed by scanning the laser beam emitted from the exposing section and modulated on the basis of the image data read by the scanner section 140 so as to form a latent image on it. Successively, in the developing section, toner particles are absorbed onto the photoreceptor drum, and then, the toner image formed on the photoreceptor drum is transferred onto the transfer material. Finally, in the fixing section, the toner image is fixed onto the transfer material by applying heat and pressure onto the transfer material with the toner image.

The I/F section 160 is provided with a modem, a LAN interface, a USB, etc., and has a function for coupling the copier 100 to the communication network N so as to conduct the data communicating operations.

The storage section 170 serves as a functional section for conducting the data read/write operations for the storage medium, such as, for instance, a VRAM (Video Random Access Memory), a CD-ROM, a memory card, a hard disc, etc. A magnetic storage medium, an optical storage medium, a semiconductor storage medium, etc. can be employed as the abovementioned storage medium, which stores application programs, various data processed by executing various kinds of processing programs, the image data read by the scanner section 140, setting contents of the copy function set by the user, etc. Further, as shown in FIG. 3, the storage section 170 stores the main operational screen data 172, the remote operating screen data 174, the script data 176, the operating screen data 178 and the output image data 180 in it.

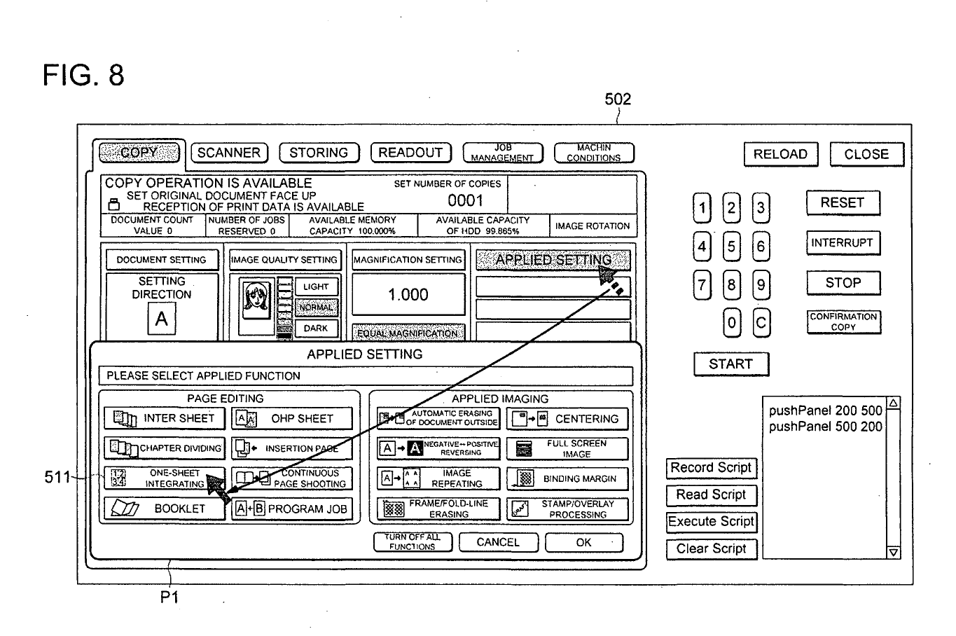

The main operational screen data 172 serve as image data (for instance, in the form of HTML) for displaying the main operating screen 200 including the main operating panel screen 210 and the detailed setting panel, etc. When any one of the buttons on the main operating panel screen 210 is pushed, or any one of the buttons on the remote setting panel 410 of the remote terminal device 300 is clicked, the control section 110 generates the main operational screen data 172 so as to revise it as new data. Further, based on the revised main operational screen data 172, the main operating screen 200, in which the detailed setting panel (for instance, an applied setting panel P1 in the form of the Windows format shown in FIG. 8) overlaps the main operating panel screen 210, is displayed.

The remote operating screen data 174 serve as image data (for instance, in the form of HTML) for displaying the remote operating screen 400 on the remote terminal device 300. The control section 110 generates image data sets for displaying the hard key panel 430 and the script panel 450, and then, generates the remote operating screen data 174 by combining and synthesizing the generated image data sets with the main operational screen data 172.

Receiving the coordinate data from the remote terminal device 300, the control section 110 compares the (x, y) values, represented by the received coordinate data, with the remote operating screen data 174, so as to detect the position clicked on the remote operating screen 400. Then, when the control section 110 determines that a button displayed on the remote setting panel 410 is clicked, the control section 110 generates the main operational screen data 172 for displaying the detailed setting panel corresponding to the clicked button on the main operating panel screen 210 so as to revise it as new data. While, when the control section 110 determines that a button displayed on the hard key panel 430 is clicked, the control section 110 deems that the corresponding hard-key button on the hard keys section 122 is pushed down, and conducts the processing operation corresponding to the hard-key button concerned (for instance, the commencement or the reset of the copy), and further, generates the main operational screen data 172 for displaying the operating status indication area 414 so as to revise it as new data.

At the same time when revising the main operational screen data 172 in response to the user's operational input, the control section 110 also revises the remote operating screen data 174, based on the revised main operational screen data 172, and then, transmit the revised remote operating screen data 174 to the remote terminal device 300, in order to make the remote terminal device 300 revise the display of the remote operating screen 400. For this purpose, the remote terminal device 300 can display the remote operating screen 400 including the remote setting panel 410 which is the same as the main operating panel screen 210, based on the remote operating screen data 174, while the copier 100 displays the main operating panel screen 210 based on the main operational screen data 172.

The script data 176, being operating procedure information, serve as a data table in which the consecutive operations to be conducted in the remote terminal device 300 of the user are recorded as the operating procedure information in the time domain series. Based on the coordinate data received from the remote terminal device 300, the control section 110 determines which position in the hard key panel 430 or the remote setting panel 410 is clicked, and then, cumulatively stores the determined results one by one in order of the time series as the operating information in the form of the “command argument”.

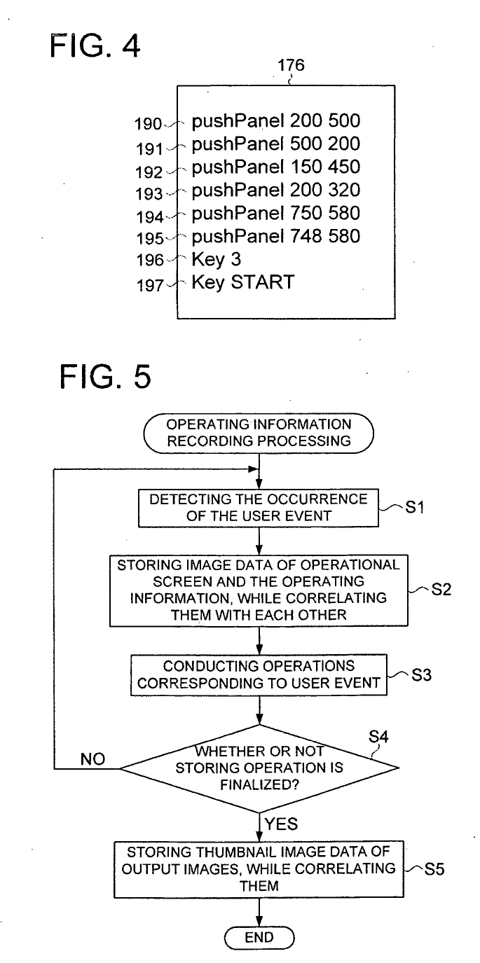

FIG. 4 shows an example of the data structure of the script data 176. For instance, operating information 190 represents an event that the position, at which coordinate values are x=“200”, y=“500” in the remote setting panel 410, is clicked, while operating information 196 represents an event that “3” of the numerical button 432 on the hard key panel 430 is clicked.

Since the control section 110 can sequentially read out the operating information stored in the script data 176 in order to conduct the processing corresponding to the operation represented by the operating information concerned, it becomes possible to reproduce the user's consecutive operations stored in the script data 176 concerned. Accordingly, it is also possible to reproduce the copy conditions established previously by the user.

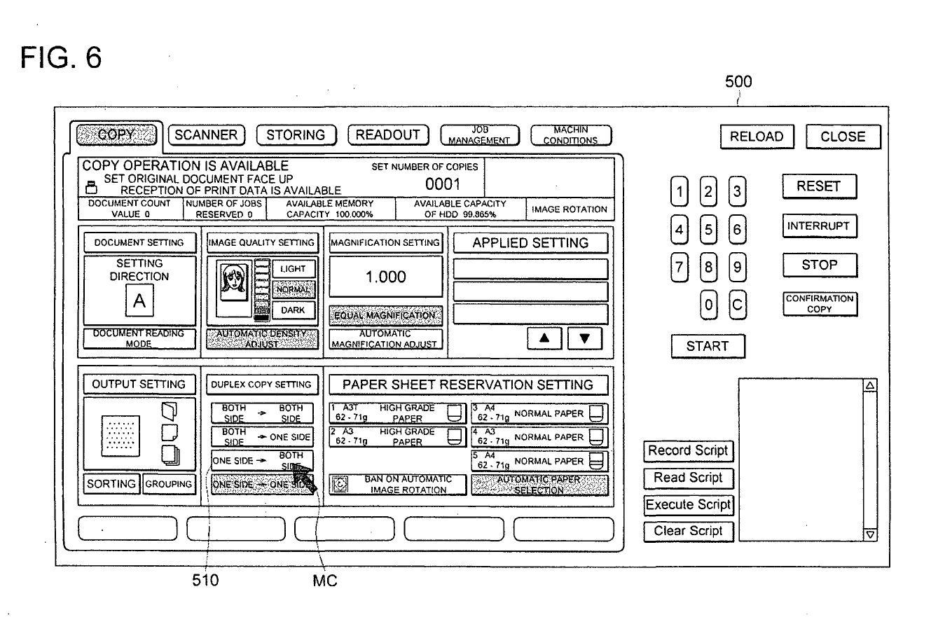

The operating screen data 178 serve as image data of consecutive operating screens, which were displayed on the display section 330 of the remote terminal device 300 corresponding to the operating procedure of the user, when recording the script data 176. In other words, the operating screen data 178 are formed by cumulatively storing the remote operating screen data 174 as the time series item. Further, each of the operating screen data 178 is correlated with each of the operating information of the script data 176. For instance, the image data for displaying an operating screen 500 (refer to FIG. 6) is correlated with the operating information 190 included in the script data 176 shown in FIG. 4. According to the correlation mentioned in the above, it can be recognized that the position, at which coordinate values are x=“200”, y=“500” in the operating screen 500, is clicked.

The output image data 180 serve as thumbnail image data of the images outputted by the copier 100 when recording the script data 176.

When recording the script data 176, the control section 110 stores both the script data 176 and the operating screen data 178 in the storage section 170 while correlating them with each other, and further, also stores the output image data 180 while correlating the output image data 180 with both the script data 176 and the operating screen data 178.

<Concrete Operations of Remote Operating System 1>

Next, concrete operations of remote operating system 1 will be detailed in the following.

Initially, referring to FIG. 5, an operating information recording processing will be detailed. The operating information recording processing is conducted on the basis of an operating information recording program stored in the ROM of the control section 110 or the storage section 170. When the control section 110 of the copier 100 determines from the coordinate data transmitted from the remote terminal device 300 that the recording button 454 of the script panel 450 is clicked, the control section 110 reads out the operating information recording program in order to commence the operating information recording processing based on the program concerned.

The control section 110 waits an occurrence of a user event in its standby state. Hereinafter, the user event is defined as an event caused by an operating action conducted by the user. Concretely speaking, the user event would be a reception of the coordinate data transmitted from the remote terminal device 300 as a result of an action for clicking the mouse 322.

As shown in FIG. 5, the flowchart of the operating information recording processing to be conducted by the control section 110 includes the steps of: detecting the occurrence of the user event (Step S1); determining a kind of the operation, conducted by the user in the site of the remote terminal device 300, from the coordinate data received; storing the image data of the operational screen displayed on the display section 330 of the remote terminal device 300 at the time of the operation (the remote operating screen data 174) and the operating information representing the action conducted by the user, while correlating them with each other (Step S2), wherein the image data of the operational screen are stored as the operating screen data 178 in the storage section 170, and the operating information are stored as the script data 176 in the storage section 170; revising the main operational screen data 172 and the remote operating screen data 174, and transmitting the operational instruction to each of the functional sections (for instance, renewals of copy settings, such as a magnification setting, a number of copies, a size of document, etc., and the commencement of the copy operation), in response to the operational actions conducted by the user (Step S3); determining that the storing operation of the operating information should be finalized, when the coordinate data of the start button 442 are received (Step S4, Yes); storing the thumbnail image data outputted from the copier 100 and established as the output image data 180, while correlating the output image data 180 with the operating screen data 178 and the script data 176 (Step S5); and finalizing the operating information recording processing.

When determining that the storing operation of the operating information should be continued (Step S4, No), the processing step returns to Step S1, and the processing steps form Step S1 to Step S4 are repeated so as to store the operating screen data 178 and the script data 176 in response to the occurrence of the user event.

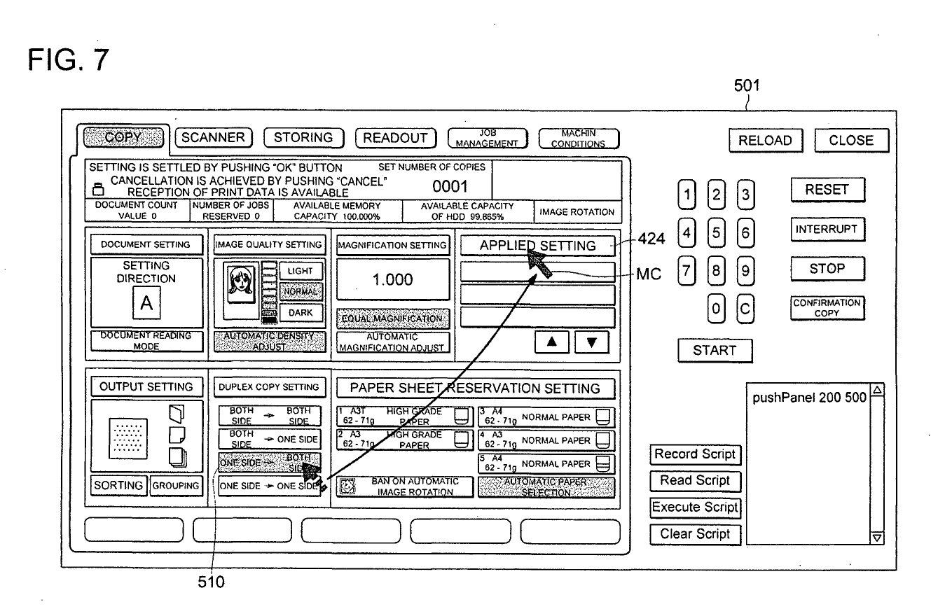

For instance, when the user clicks a “ONE-SIDE→BOTH-SIDES” button 510 for the duplex copy setting, the coordinate data (x=“200”, y=“500”) of the mouse cursor MC on the “ONE-SIDE→BOTH-SIDES” button 510 are transmitted to the copier 100. The control section 110 of the copier 100 stores the image data of the operating screen 500 and the operating information 190 shown in FIG. 4, while correlating them with each other. As mentioned in the above, every time when the user conducts the clicking action in the site of the remote terminal device 300, the image data of the operating screen are recorded into the operating screen data 178, and the operating information are stored in the script data 176 as the time series item. In response to the action for clicking the “ONE-SIDE→BOTH-SIDES” button 510, as shown in FIG. 7, the operating screen 501 in the state of selecting the “ONE-SIDE→BOTH-SIDES” button 510 is displayed on the display section 330.

Next, when the user clicks an applied setting button 424 in the operating screen 501 shown in FIG. 7, the coordinate data (x=“500”, y=“200”) of the mouse cursor MC are transmitted to the copier 100. The control section 110 of the copier 100 stores the image data of the operating screen 501 and the operating information 191 shown in FIG. 4, while correlating them with each other. In response to the action for clicking the applied setting button 424, as shown in FIG. 8, the operating screen 502 on which the applied setting panel P1 overlaps is displayed on the display section 330.

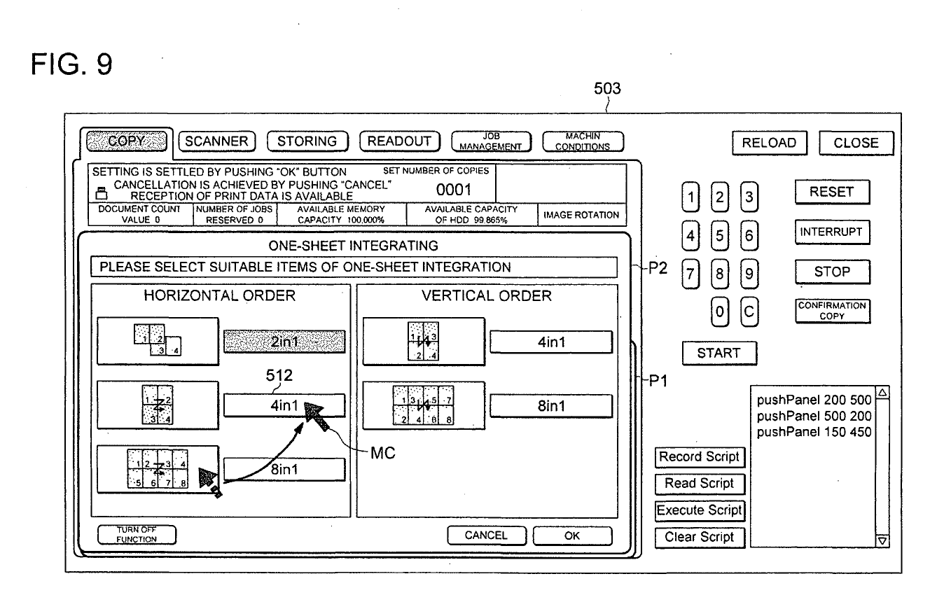

Successively, when the user clicks a one-sheet integrating button 511 in the operating screen 502 shown in FIG. 8, the coordinate data (x=“150”, y=“450”) of the mouse cursor MC are transmitted to the copier 100. The control section 110 of the copier 100 stores the image data of the operating screen 502 and the operating information 192 shown in FIG. 4, while correlating them with each other. In response to the action for clicking the one-sheet integrating button 511, as shown in FIG. 9, the operating screen 503 on which a one-sheet integrating panel P2 overlaps is displayed on the display section 330.

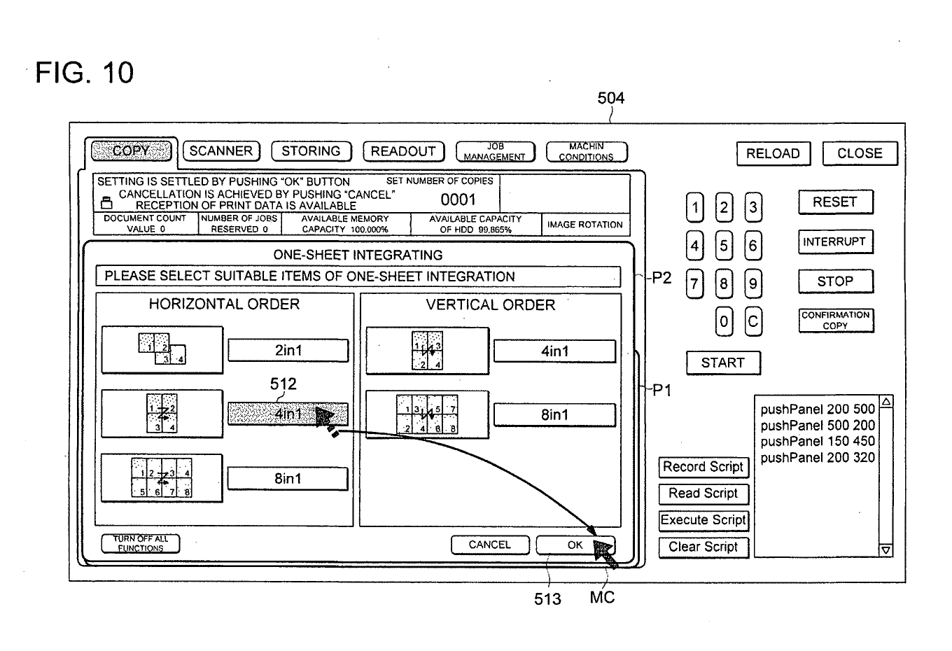

Still successively, when the user clicks a 4in1 button 512 in the operating screen 503 shown in FIG. 9, the coordinate data (x=“200”, y=“320”) of the mouse cursor MC are transmitted to the copier 100. The control section 110 of the copier 100 stores the image data of the operating screen 503 and the operating information 193 shown in FIG. 4, while correlating them with each other. In response to the action for clicking the 4in1 button 512, as shown in FIG. 10, the operating screen 504 in the state of selecting the 4in1 button 512 is displayed on the display section 330.

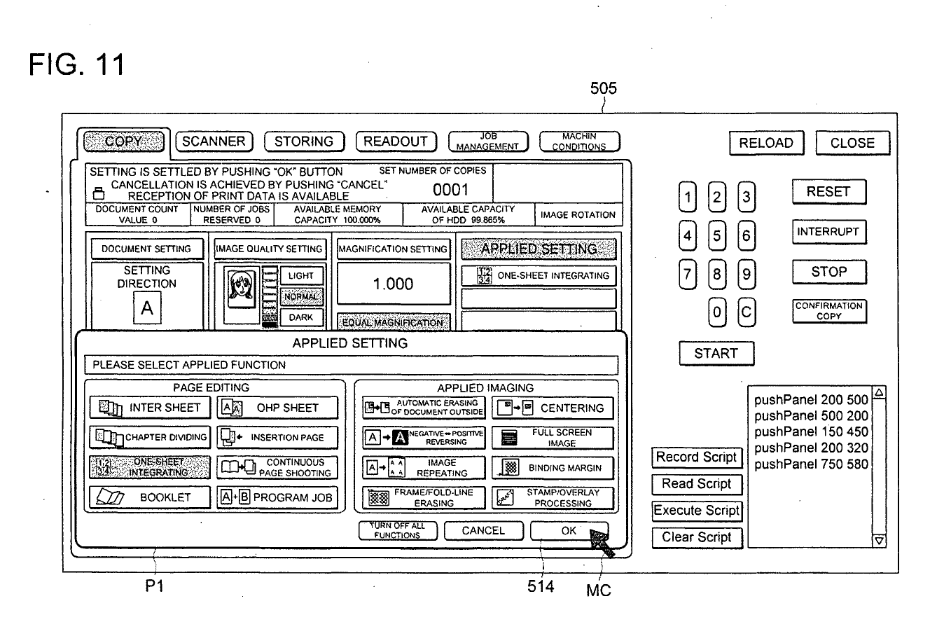

Still successively, when the user clicks an OK button 513 in the operating screen 504 shown in FIG. 10, the coordinate data (x=“750”, y=“580”) of the mouse cursor MC are transmitted to the copier 100. The control section 110 of the copier 100 stores the image data of the operating screen 504 and the operating information 194 shown in FIG. 4, while correlating them with each other. In response to the action for clicking the OK button 513, the one-sheet integrating panel P2 is closed and, as shown in FIG. 11, the operating screen 505 is displayed on the display section 330.

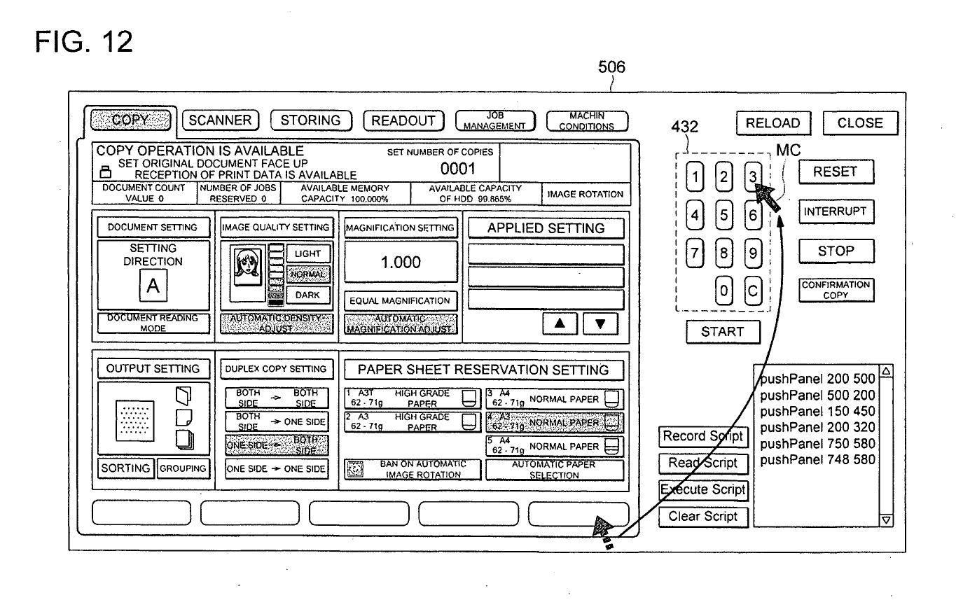

Still successively, when the user clicks an OK button 514 in the operating screen 505 shown in FIG. 11, the coordinate data (x=“748”, y=“580”) of the mouse cursor MC are transmitted to the copier 100. The control section 110 of the copier 100 stores the image data of the operating screen 505 and the operating information 195 shown in FIG. 4, while correlating them with each other. In response to the action for clicking the OK button 514, the applied setting panel P1 is closed and, as shown in FIG. 12, the operating screen 506 is displayed on the display section 330.

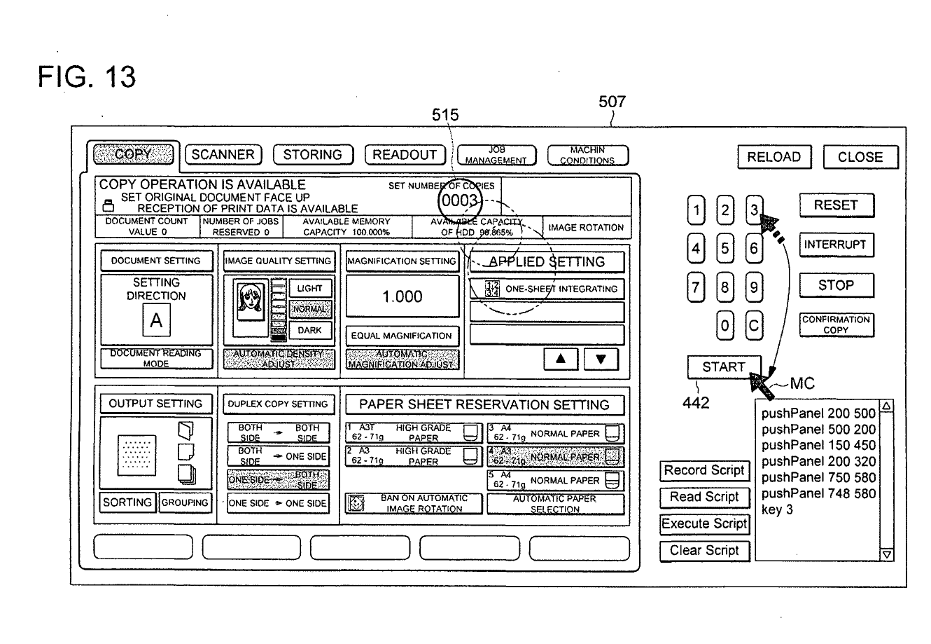

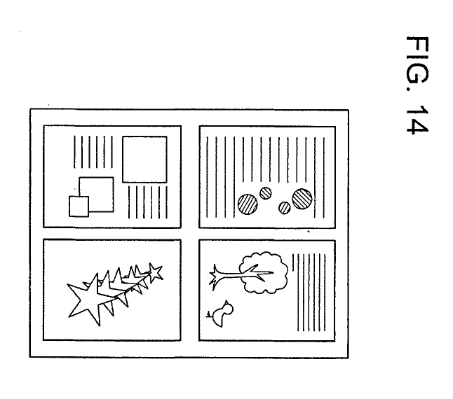

Still successively, when the user clicks “3” of the numerical button 432 in the operating screen 506 shown in FIG. 12, the coordinate data of the mouse cursor MC are transmitted to the copier 100. The control section 110 of the copier 100 stores the image data of the operating screen 506 and the operating information 196 shown in FIG. 4, while correlating them with each other. In response to the action for clicking “3” of the numerical button 432, as shown in FIG. 13, the operating screen 507 is displayed on the display section 330. In the operating screen 507, the number of copies is set at “0003”.

Yet successively, when the user clicks the start button 442 in the operating screen 507 shown in FIG. 13, the coordinate data of the mouse cursor MC are transmitted to the copier 100. The control section 110 of the copier 100 stores the image data of the operating screen 507 and the operating information 197 shown in FIG. 4, while correlating them with each other. In response to the action for the start button 442, the copier 100 outputs the copy images. The control section 110 stores the thumbnail image data, shown in FIG. 13, as the output image data 180, while correlating the output image data 180 with the operating screen data 178 and the script data 176.

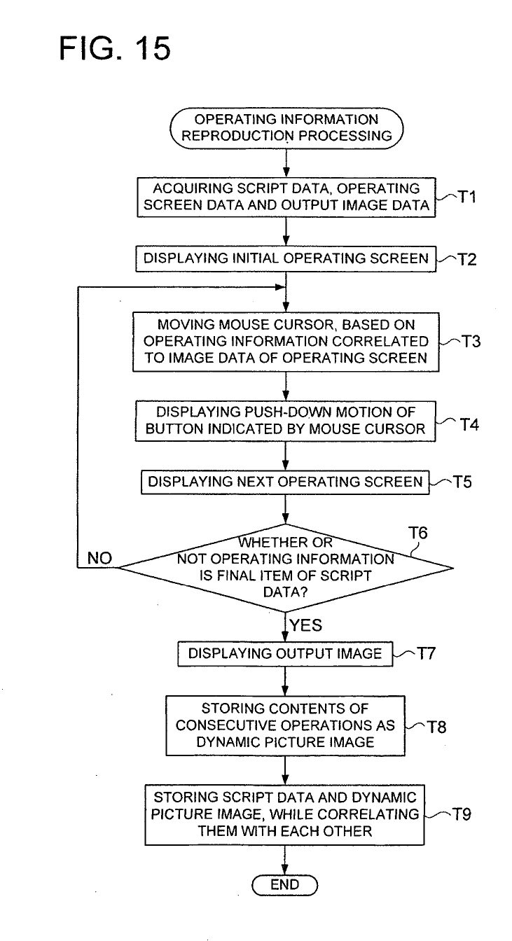

Next, referring to FIG. 15, the operating information reproduction processing will be detailed in the following. The operating information reproduction processing is such a processing that reproduces the operating screens once displayed on the display section 330, based on the script data 176 and the operating screen data 178, and is conducted on the basis of an operation information reproducing program stored in the ROM or the storage section 350 provided in the control section 310 of the remote terminal device 300. Incidentally, the operating information reproduction processing is conducted only for confirming the contents of the operations. Accordingly, in the operating information reproduction processing, the copier 100 does not conduct the real operations (such as various kinds of setting operations, the copy operation, etc.).

As shown in FIG. 15, the flowchart of the operating information reproduction processing to be conducted by the control section 310 includes the steps of: acquiring the script data 176, the operating screen data 178 and the output image data 180, which are correlated with each other, from the storage section 170 of the copier 100 (Step T1); storing the acquired data of the script data 176, the operating screen data 178 and the output image data 180 into the storage section 350; reading out image data of an initial operating screen from the operating screen data 178 to display the initial operating screen on the display section 330 (Step T2); reading out the operating information correlated with the image data of the operating screen currently displayed from the script data 176 so as to move the mouse cursor MC on the operating screen, based on the operating information concerned (Step T3); displaying as if the button indicated by the mouse cursor MC were pushed down at the position based on the operating information (Step T4); reading out image data of the next operating screen from the operating screen data 178 to display the next operating screen on the display section 330 (Step T5), wherein it is applicable that a portion displayed in the operating screen, which is changed by the operation corresponding to the operating information, is indicated by a making symbol or the like so as to emphasize the portion concerned; determining whether or not the operating information read out in Step T3 is the final item of the script data 176 (Step T6); and returning to Step T3, when not in Step T6, in order to read out the operating information correlated with the image data of the operating screen currently displayed from the script data 176 so as to move the mouse cursor MC on the operating screen, based on the operating information concerned (Step T3). As mentioned in the above, by repeating the processing from Step T3 to Step T6, the consecutive operating screens are sequentially displayed one by one on the display section 330 according to the operating procedures.

The flowchart of the operating information reproduction processing to be conducted by the control section 310 further includes the steps of: displaying the output image based on the output image data 180 on the display section 330 (Step T7), when determining that the operating information read out in Step T3 is the final item of the script data 176 (Step T6, Yes), wherein it is applicable that the property information, such as the file name of the output image data 180, the folder name of the storage device, the information indicating the copier 100 which output the image, etc., are also displayed as the character information associated with the output image; storing the contents of the consecutive operations displayed on the display section 330 in the steps from Step T2 to Step T7 into the storage section 350 as a dynamic picture image (Step T8); storing the script data 176 into the storage section 350, while correlating the script data 176 with the dynamic picture image concerned; and finalizing the operating information reproduction processing.

Incidentally, each of the moving attitude of the mouse cursor MC and the time period when revising the display of the operating screen is set at such a velocity that is recognizable for the user.

For instance, when the operating information reproduction processing is conducted on the basis of the script data 176 shown in FIG. 4, the image data (operating screen data 178) of the operating screens 500-507 shown in FIGS. 6-13 and the output image data 180 indicated in FIG. 14, at first, the operating screen 500 shown in FIG. 6 is displayed on the display section 330 as the initial operating screen. Then, based on the operating information 190 of “pushpanel 200 500 ” shown in FIG. 4, which is correlated with the image data of the operating screen 500, the mouse cursor MC moves onto the “ONE-SIDE→BOTH-SIDES” button 510 of the operating screen 500, and it is displayed as if the “ONE-SIDE→BOTH-SIDES” button 510 were pushed down.

Next, as shown in FIG. 7, the operating screen 501 in which the “ONE-SIDE→BOTH-SIDES” button 510 is selected is displayed on the display section 330. Then, based on the operating information 191 of “pushPanel 500 200” shown in FIG. 4, which is correlated with the image data of the operating screen 501, the mouse cursor MC moves onto the applied setting button 424 of the operating screen 501, and it is displayed as if the applied setting button 424 were pushed down.

Successively, as shown in FIG. 8, the operating screen 502 on which the applied setting panel P1 overlaps is displayed on the display section 330. Then, based on the operating information 192 of “pushPanel 150 450” shown in FIG. 4, which is correlated with the image data of the operating screen 502, the mouse cursor MC moves onto the one-sheet integrating button 511 of the operating screen 502, and it is displayed as if the one-sheet integrating button 511 were pushed down.

Still successively, as shown in FIG. 9, the operating screen 503 on which the one-sheet integrating panel P2 overlaps is displayed on the display section 330. Then, based on the operating information 193 of “pushPanel 200 320” shown in FIG. 4, which is correlated with the image data of the operating screen 503, the mouse cursor MC moves onto the 4in1 button 512 of the operating screen 503, and it is displayed as if the 4in1 button 512 were pushed down.

Still successively, as shown in FIG. 10, the operating screen 504 in which the 4in1 button 512 is selected is displayed on the display section 330. Then, based on the operating information 194 of “pushpanel 750 580” shown in FIG. 4, which is correlated with the image data of the operating screen 504, the mouse cursor MC moves onto the OK button 513 of the operating screen 504, and it is displayed as if the OK button 513 were pushed down.

Still successively, the operating screen 505 shown in FIG. 11 is displayed on the display section 330. Then, based on the operating information 195 of “pushpanel 748 580” shown in FIG. 4, which is correlated with the image data of the operating screen 505, the mouse cursor MC moves onto the OK button 514 of the operating screen 505, and it is displayed as if the OK button 514 were pushed down.

Still successively, the operating screen 506 shown in FIG. 12 is displayed on the display section 330. Then, based on the operating information 196 of “key 3” shown in FIG. 4, which is correlated with the image data of the operating screen 506, the mouse cursor MC moves onto “3” of the numerical button 432 of the operating screen 506, and it is displayed as if “3” of the numerical button 432 were pushed down.

Yet successively, the operating screen 507 shown in FIG. 13 is displayed on the display section 330. In the operating screen 507, the number of copies is set at “0003”, as the result of the operation in the operating screen 506 shown in FIG. 12. As shown in FIG. 13, it is applicable that the number of copies “0003” is encircled by a mark 515 so as to emphasize the revised portion. Further, when the mark 515 is displayed, by moving the mark 515 from another position to the emphasized position, it is possible to improve the effect of the enhancement than ever. Then, based on the operating information 197 of “key START” shown in FIG. 4, which is correlated with the image data of the operating screen 507, the mouse cursor MC moves onto the start button 442 of the operating screen 507, and it is displayed as if the start button 442 were pushed down.

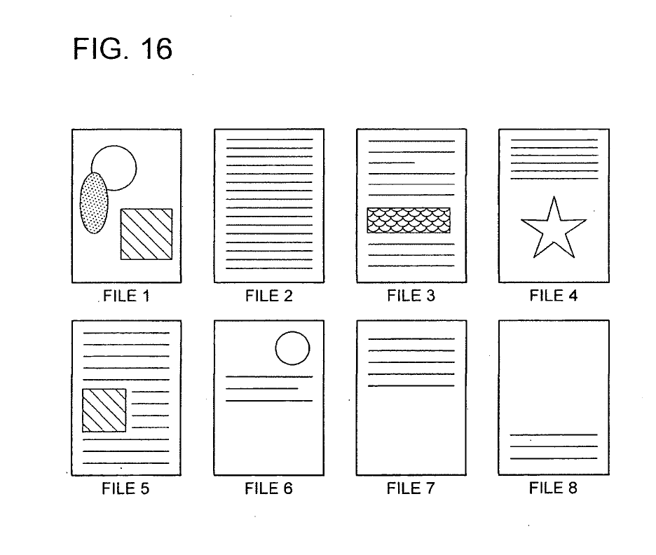

Finally, the display of the operating screen is finalized, and, as shown in FIG. 14, the output image based on the output image data 180 is displayed on the display section 330. Incidentally, it is applicable that the output image is displayed for every page or every job. For instance, as shown in FIG. 16, it is also applicable that a list of the output images is displayed, and the file name is indicated for each of the output images.

As described in the foregoing, according to the present embodiment, since the script data 176, the operating screen data 178 and the output image data 180 are stored while correlating them with each other, it becomes possible to easily confirm each of the operating screens later on, and therefore, it also becomes possible to easily grasp the contents of the operations conducted for the copier 100.

Further, since the output image data 180 are stored, it becomes possible to refer to the output images when analyzing the malfunction of the copier 100. In addition, it also becomes possible to prevent the copier 100 from being used for an injustice purpose, such as an injustice copy operation, etc.

Still further, since the output image data 180 are the thumbnail image data, it is possible to reduce the storage capacity for storing the image data, compared to the case of storing the image data of real image size. However, it is possible to make it a user selectable item whether the thumbnail image data or the real-sized image data should be stored.

Incidentally, when the output image data 180 are not necessary, only the script data 176 and the operating screen data 178 are stored while correlating them each other.

Still further, since, based on the script data 176 and the operating screen data 178 correlated with the script data 176, the consecutive operating screens are sequentially displayed one by one on the display section 330 corresponding to the operating procedures, and, at the same time, the mouse cursor MC for indicating the operating procedure on each of the operating screens is also displayed, it becomes possible to easily grasp the contents of the operations conducted for the copier 100.

Yet further, since the contents of the operations conducted for the copier 100 are stored as the dynamic picture image file, by reproducing the dynamic picture image file, it becomes possible to easily grasp the contents of the operations.

### MODIFIED EXAMPLES

In the foregoing, the example in which the present invention is applied to the remote operating system 1 has been described. However, the scope of the present invention is not limited to such the remote operating system 1 mentioned in the above. The preferred embodiment could be modified as needed, as described in the following.

For instance, although, in the abovementioned embodiment, the script data 176, the operating screen data 178 and the output image data 180 are stored in the copier 100 side, it is also applicable that those are stored in the storage section 350 of the remote terminal device 300 side in response to the operations conducted by the user. Further, it is also applicable that the operating information recording program is stored in the remote terminal device 300 side, so that the control section 310 of the remote terminal device 300 implements the operating information recording processing.

Further, although, in the abovementioned embodiment, the operating information reproduction processing is conducted in the remote terminal device 300 side, it is also applicable that the operating information reproduction program is stored in the copier 100 side, so that the control section 110 of the copier 100 implements the operating information reproduction processing. At that time, the consecutive operating screens are possibly displayed either on the display section 130 of the copier 100 or on the display section 330 of the remote terminal device 300 after transmitting the image data of them to the remote terminal device 300. With respect to the dynamic picture image file to be stored in the storage section 350 in the operating information reproduction processing, it is also applicable that the dynamic picture image file is stored in the storage section 170 of the copier 100 side.

Still further, it is applicable that, after completing the operating information recording processing, the dynamic picture image file for reproducing the contents of the operations is successively generated so as to store it together.

Still further, although, in the abovementioned embodiment, the image data of the operating screens are stored, it is also applicable that the code information corresponding to the each of the operating screens are stored instead of the image data. In the case of storing the code information, it becomes possible to reduce the storage capacity for storing the information in regard to the consecutive operating screens to a smaller level, compared to the case of storing the image data.

Still further, instead of displaying the movements and the clicking actions of the mouse cursor MC on the operating screens in the continuous dynamic picture image as aforementioned in the present embodiment, it is also applicable that the movements and the clicking actions are simply displayed one by one along the time series of the operations (slide-show type display method). Further, when displaying the dynamic picture image, it is possible to cut or shorten the transient times of the screen changes, which are obvious or self-evident for the user, so as to achieve the high-speed display mode. Alternatively, it is also applicable that a plurality of operating screens are displayed on a single screen by aligning them in a line, so as to make it possible to recognize the flow of the operating screens at one sight (one-screen integrating type display method). Further, other than the images of the operating screens, for instance, it is also applicable that the consecutive dynamic picture image is generated by mixing the watching images, etc., which are captured from the outside of the copier 100 and comply with the time series, in it.

Still further, it is also applicable that the operating actions conducted by the user at the operating section 120 of the copier 100 are stored in the storage section 170 of the copier 100 as the script data 176. In this case, in Step S1 of the operating information recording processing shown in FIG. 5, by detecting an occurrence of the user event that the operating section 120 of the copier 100 is operated, the script data 176 can be stored.

Still further, although, in the abovementioned embodiment, the all area of the operating screen displayed on the display section 330 of the remote terminal device 300 is reproduced in the operating information reproduction processing, it is also applicable that, when displaying the contents of the operations on the remote setting panel 410, only the remote setting panel 410 is displayed, while, when displaying the contents of the hard key panel 430, the hard key panel 430 is displayed by scrolling the screen as needed.

Still further, although, in the abovementioned embodiment, the processing is commenced by clicking the recording button 454 and the recording operation is finalized by clicking the start button 442, it is also applicable that the script data 176, the operating screen data 178 and the output image data 180 are periodically stored for every predetermined time period, irrespective of the instruction of the user.

Still further, it is also applicable that the compression processing and/or the encryption processing are/is applied to the script data 176, the operating screen data 178 and the output image data 180, when storing them. By compressing the data, it becomes possible to reduce the storage capacity for storing them at lower level. By encrypting the data, it becomes possible to maintain the security of the data.

Still further, the scope of the system configuration of the remote operating system 1 is not limited to the aforementioned embodiment. For instance, the system configuration, which is provided with a plurality of remote terminal devices, would be applicable in the present invention. In this case, a plurality of the script data 176, the operating screen data 178 and the output image data 180, which are acquired by setting operations conducted in the plurality of remote terminal devices, are stored in the copier 100. Accordingly, it becomes possible for the user residing at a separate remote terminal device to confirm the contents of the operations conducted in another remote terminal device.

Yet further, it is also applicable that the remote operating system 1 has such a system configuration, in which a plurality of copiers are coupled to a single remote terminal device 300 through the network.

According to the present invention, the following effects can be attained.
(1) It becomes possible to easily grasp the contents of the operations conducted for the apparatus.
(2) It becomes possible to refer to the output data outputted from the apparatus when analyzing the malfunction of the apparatus.
(3) It becomes possible to refer to the output data outputted from the image forming apparatus when analyzing the malfunction of the image forming apparatus
(4) It becomes possible to store the data in the storage having a storing capacity smaller than ever.
(5) Since the image data representing each of the operating screens are stored, it becomes possible to easily confirm each of the operating screens.
(6) Since the code information for specifying each of the operating screens are stored, it becomes possible to store the operating screen information with respect to the consecutive operating screens in the storage having a storing capacity smaller than ever.
(7) Since the consecutive operating screens are sequentially displayed one by one while displaying the operating pointer for indicating the operating procedure on each of the operating screens, it becomes possible to easily grasp the contents of the operations conducted for the apparatus.
(8) Since the components of the operations conducted for the apparatus are stored as the dynamic picture file, it becomes possible to easily grasp the contents of the operations.

While the preferred embodiments of the present invention have been described using specific term, such description is for illustrative purpose only, and it is to be understood that changes and variations may be made without departing from the split and scope of the appended claims.

What is claimed is:

1. An operating information recording method, comprising:
storing operating procedure information including consecutive operating information according to an operating procedure against to an apparatus as a procedure in time series; and
storing operating screen information with respect to consecutive operating screens to be displayed on a display section corresponding to the operating procedure, while correlating the operating screen information with the operating procedure information.

2. The operating information recording method of claim 1, further comprising:
storing output data information with respect to output data, which are outputted form the apparatus operated according to the operating procedure, while correlating the output data information with the operating procedure information and the operating screen information.

3. The operating information recording method of claim 2,
wherein the apparatus is an image forming apparatus, and the output data are image data.

4. The operating information recording method of claim 3,
wherein the output data information includes thumbnail image data.

5. The operating information recording method of claim 1,
wherein the operating screen information includes image data of each of the consecutive operating screens.

6. The operating information recording method of claim 1,
wherein the operating screen,information includes code information for specifying each of the consecutive operating screens.

7. An operating information reproducing method, comprising:
acquiring operating procedure information including consecutive operating information according to an operating procedure against to an apparatus as a procedure in time series;
acquiring operating screen information with respect to consecutive operating screens correlated with the operating procedure information; and
displaying the consecutive operating screens on a display section corresponding to the operating procedure, and at a same time, displaying an operating pointer for indicating the operating procedure on the consecutive operating screens, based on the operating procedure information and the operating screen information.

8. An operating information reproducing method, comprising:
acquiring operating procedure information including consecutive operating information according to an operating procedure against to an apparatus as a procedure in time series;
acquiring operating screen information with respect to consecutive operating screens correlated with the operating procedure information; and
displaying the consecutive operating screens on a display section corresponding to the operating procedure, and at a same time, generating a dynamic picture image file for displaying an operating pointer for indicating the operating procedure on the consecutive operating screens, based on the operating procedure information and the operating screen information; and
storing the dynamic picture image file.

9. The operating information reproducing method of claim 8,
wherein the dynamic picture image file is correlated with the operating procedure information when storing the dynamic picture image file.

10. An apparatus, comprising:
a display section;
a storage section to store information; and
a control section to control the storage section so as to store operating procedure information including consecutive operating information according to an operating procedure against to an apparatus as a procedure in time series and operating screen information with respect to consecutive operating screens to be displayed on the display section corresponding to the operating procedure, while correlating the operating screen information with the operating procedure information.

11. An apparatus, comprising
a display section; and
a control section to acquire operating procedure information including consecutive operating information according to an operating procedure against to an apparatus as a procedure in time series, and operating screen information with respect to consecutive operating screens correlated with the operating procedure information, and to control the display section so as to display the consecutive operating screens on the display section corresponding to the operating procedure, and at a same time, so as to display an operating pointer for indicating the operating procedure on the consecutive operating screens, based on the operating procedure information and the operating screen information.

12. An apparatus, comprising:
a storage section to store information; and
a control section to acquire operating procedure information including consecutive operating information according to an operating procedure against to an apparatus as a procedure in time series, and operating screen information with respect to consecutive operating screens correlated with the operating procedure information, and to control the display section so as to display the consecutive operating screens on a display section corresponding to the operating procedure, based on the operating procedure information and the operating screen information, and to generate a dynamic picture image file for displaying an operating pointer for indicating the operating procedure on the consecutive operating screens, based on the operating procedure information and the operating screen information, so as to store the dynamic picture image file in the storage section.

13. A computer program for executing a specific operation against to an apparatus, comprising the functional steps of:
storing operating procedure information including consecutive operating information according to an operating procedure against to an apparatus as a procedure in time series; and
storing operating screen information with respect to consecutive operating screens to be displayed on a display section corresponding to the operating procedure, while correlating the operating screen information with the operating procedure information.

14. A computer program for executing a specific operation against to an apparatus, comprising the functional steps of:
acquiring operating procedure information including consecutive operating information according to an operating procedure against an apparatus as a procedure in time series;
acquiring operating screen information with respect to consecutive operating screens correlated with the operating procedure information; and
displaying the consecutive operating screens on a display section corresponding to the operating procedure, and at a same time, displaying an operating pointer for indicating the operating procedure on the consecutive operating screens, based on the operating procedure information and the operating screen information.

15. A computer program for executing a specific operation against to an apparatus, comprising the functional steps of:
acquiring operating procedure information including consecutive operating information according to an operating procedure against an apparatus as a procedure in time series;
acquiring operating screen information with respect to consecutive operating screens correlated with the operating procedure information; and
displaying the consecutive operating screens on a display section corresponding to the operating procedure, and at a same time, generating a dynamic picture image file for displaying an operating pointer for indicating the operating procedure on the consecutive operating screens, based on the operating procedure information and the operating screen information; and
storing the dynamic picture image file.
